(19) United States
(12) Patent Application Publication
(10) Pub. No.: US 2013/0138502 A1
(43) Pub. Date: May 30, 2013

(54) Method for Determining Marketing Communications Sales Attribution and a System Therefor

(71) Applicant: Kiran Rama, Vidyaranyapura (IN)

(72) Inventor: Kiran Rama, Vidyaranyapura (IN)

(73) Assignee: DELL PRODUCTS, LP, Round Rock, TX (US)

(21) Appl. No.: 13/305,147

(22) Filed: Nov. 28, 2011

(51) Int. Cl. G06Q 30/02

(52) U.S. Cl. 705/14.45

(57) ABSTRACT

For each visit to a business web site, an identity of a visitor and an identity of a corresponding marketing vehicle are received. A respective portion of sales revenue is attributed to each marketing vehicle based on an individual probability that a first visit by a visitor is associated with a first marketing vehicle, and a joint probability that a second visit by the visitor is associated with a second marketing vehicle.

### FIELD OF THE DISCLOSURE

This disclosure generally relates to information handling systems, and more particularly relates to attributing sales to marketing communications using an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements can vary between different applications, information handling systems can also vary regarding what information is handled, how the information is handled, how much information is processed, stored, or communicated, and how quickly and efficiently the information can be processed, stored, or communicated. The variations in information handling systems allow for information handling systems to be general or configured for a specific user or specific use such as financial transaction processing, airline reservations, enterprise data storage, or global communications. In addition, information handling systems can include a variety of hardware and software components that can be configured to process, store, and communicate information and can include one or more computer systems, data storage systems, and networking systems.

Today, information handling systems are integrated in many aspects of a business. This is especially true for businesses that conduct most of their operations online. These so-called electronic (E-) commerce business can utilize information handling systems to support marketing, sales transactions, inventory management, customer services, and the like. For example, an E-commerce business may utilize one or more marketing communications (MarCom) vehicles that serve to promote the business and solicit prospective customers to visit the business.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating a marketing communications (MarCom) vehicle attribution system according to an embodiment of the present disclosure;

FIG. 2 is a block diagram illustrating operation of a data aggregation module of FIG. 1 in a specific embodiment of the present disclosure;

FIG. 3 is a table illustrating MarCom visitor records in accordance with a specific embodiment of the present disclosure;

FIG. 4 is a block diagram illustrating a Bayesian network corresponding to the visitor record information of FIG. 3 in accordance with a specific embodiment of the present disclosure;

FIG. 5 is a table illustrating visitor marketing information in accordance with a specific embodiment of the present disclosure;

FIG. 6 is a flow diagram illustrating a method in accordance with a specific embodiment of the present disclosure;

FIG. 7 is a table illustrating conditional probabilities and revenue allocation based on the visitor marketing information of FIG. 5 in accordance with a specific embodiment of the present disclosure;

FIG. 8 is a table illustrating a sales attribution report in accordance with a specific embodiment of the present disclosure; and

FIG. 9 illustrates a block diagram of an information handling system according to one aspect of the disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings can certainly be utilized in this application. The teachings can also be utilized in other applications and with several different types of architectures such as distributed computing architectures, client/server architectures, or middleware server architectures and associated components.

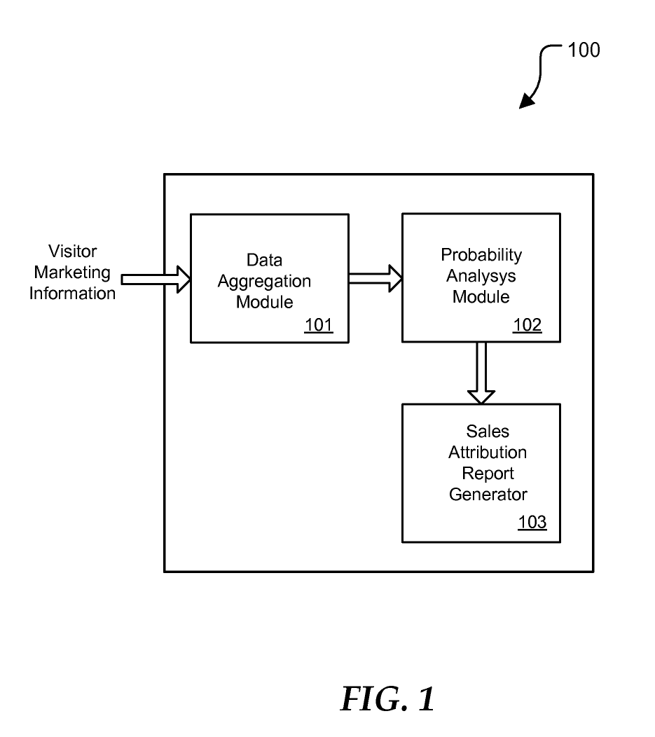

FIGS. 1-9 illustrate a marketing communications (MarCom) vehicle attribution system and associated methods. A business, such as an E-commerce business, may use the attribution system to determine the performance of individual marketing campaigns. For example, the attribution system can identify how each MarCom vehicle is contributing to customer acquisition, persuasion, and sales. MarCom vehicles can include any form of advertisement intended to entice prospective customers to visit a business. For example, MarCom vehicles can include banner advertisements displayed at an interne website, search engine based advertisements, email correspondence sent directly to prospective customers, or another marketing vehicle to direct a prospective customer to the business. Typically, a MarCom vehicle associated with an E-commerce business provides a clickable link that a prospective customer can use to navigate to the business's website. Visitors may be exposed to multiple MarCom vehicles before they make a purchase, and some MarCom vehicles may be more successful than others at attracting visitors. Therefore, it is of interest to the business to compare and evaluate the performance of each vehicle. The business can adjust and leverage their marketing resources and expenditures accordingly based on the performance evaluation.

FIG. 1 shows a MarCom vehicle attribution system 100 according to an embodiment of the present disclosure. The system 100 is configured to collect information identifying MarCom vehicles responsible for bringing potential customers to the business, and analyze the information to determine the degree to which each MarCom vehicle contributed to sales. When a visitor arrives at an E-commerce business as a result of a MarCom vehicle, information identifying the particular MarCom vehicle utilized by the visitor can be provided to the business. For example, if an individual clicks on a banner advertisement displayed on a news service web site, the identity of the news service web site and the identity of the specific banner can be communicated to the business that placed the advertisement. Therefore, a business can track how each visitor came to arrive at the business, in addition to the identity of each visitor. A prospective customer may visit an E-commerce business multiple times and via multiple MarCom vehicles before ultimately making a purchase. Furthermore, a business may employ a large number of MarCom vehicles and may receive millions of visitors.

The MarCom vehicle attribution system 100 includes a data aggregation module 101, a probability analysis module 102, and a sales attribution report generator 103. The system 100 can be implemented using one or more information handling systems. For example an information handling system, such as a web server, can be configured to execute instruction maintained at a physical storage device. The instructions can direct the information handling system to implement the methods disclosed herein. For purposes of this disclosure, an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system can be a personal computer, a PDA, a consumer electronic device, a network server or storage device, a switch router, wireless router, or other network communication device, or any other suitable device and can vary in size, shape, performance, functionality, and price. The information handling system can include memory, one or more processing resources such as a central processing unit (CPU) or hardware or software control logic. Additional components of the information handling system can include one or more storage devices, one or more communications ports for communicating with external devices as well as various input and output (I/O) devices, such as a keyboard, a mouse, and a video display. The information handling system can also include one or more buses operable to transmit communications between the various hardware components.

The data aggregation module 101 is configured to receive and store visitor marketing information over a period of time. As described above, a visit by a prospective customer to an E-commerce business web site can include information identifying the MarCom vehicle responsible for directing the individual to the business. This information, along with sales information can be stored at the data aggregation module 101. For example, the data module 101 can provide a record of each individual to visit the web site, how many times they visited, which MarCom vehicle was associated with each visit, and the value of any purchases that each visitor may have made during a visit.

The probability analysis module 102 is configured to analyze the information stored at the data aggregation module 101. In particular, the analysis module 102 employs probability-based mathematics to determine how each MarCom vehicle contributed to sales. The sales attribution report generator 103 provides a detailed allocation report identifying how sales revenue can be attributed to each MarCom vehicle.

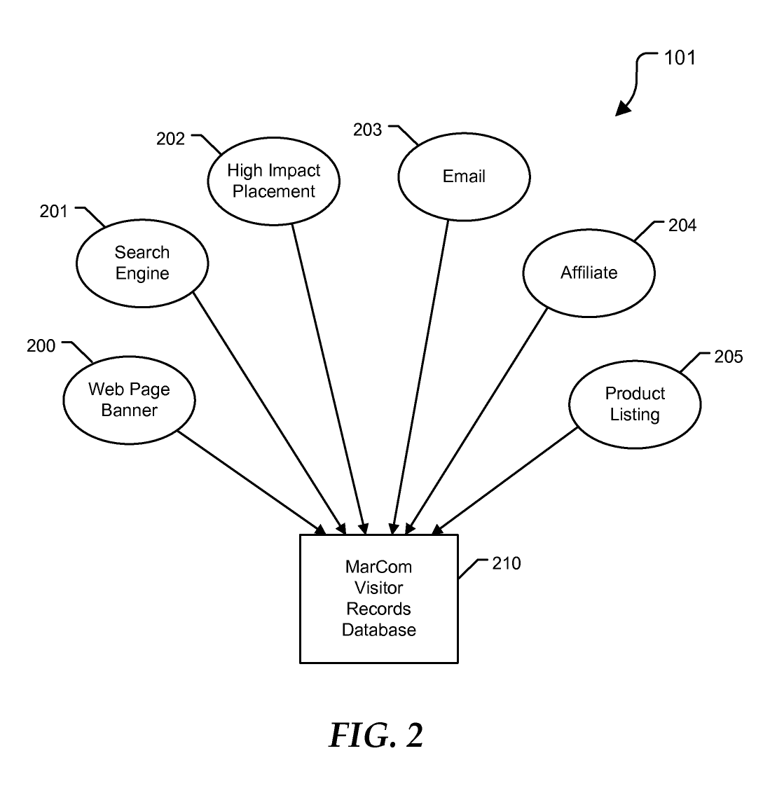

FIG. 2 shows the operation of the data aggregation module 101 in a specific embodiment of the present disclosure. The data module 101 includes a MarCom visitor records database 210, that is configured to store visitor marketing information in response to visits by prospective customers from a set of MarCom vehicles. For the purpose of example, six MarCom vehicles are illustrated: web page banner 200, search engine 201, high-impact placement 202, email 203, affiliate 204, and product listing 205. The number and type of MarCom vehicles employed by a business can differ based on the specific type of business and other considerations. Furthermore, a business can use information provided by MarCom vehicle attribution system 100 to refine the mix of MarCom vehicles deployed to support a particular product or product line to improve sales.

Each of the MarCom vehicles 200-205 provides a means for an individual to visit the business sponsoring the advertisement. This is typically accomplished by clicking a button displayed by a web browser provided by a personal computer, a cellular telephone, or another type of personal data device. Each time a prospective customer selects a link provided at a MarCom vehicle, the identity of the visitor and the identity of the particular MarCom vehicle can be transmitted to the business sponsoring the marketing vehicle, or to a designated representative. For example, in the case of a banner advertisement 200, an individual may use a mouse device to click within the boundaries of the banner image and thereby redirect their web browser to the business sponsoring the banner advertisement. The identity of the user and of the particular banner advertisement can be transmitted to the sponsoring business, where it can be stored at the database 210. An advertisement included at the search engine 201 web page can operate in a similar manner. For example, a search result displayed by the search engine can include a clickable link for directing a user to an associated business. The high-impact placement advertisement 202 may include a banner advertisement or another type of display icon, and is included here to illustrate that MarCom vehicles can be grouped with other vehicles or isolated in any manner by a user of the attribution system 100 to provide a desired degree of granularity and specificity. For example, all advertisements included at sports-related web sites can be combined into one category to identify the value of advertising to that specific market segment.

Another example of a MarCom vehicle is a direct email 203 solicitation addressed to a prospective customer, where the email message includes a clickable link that the recipient can use to visit a corresponding business web site. An affiliate 204 MarCom vehicle can include a link at a web site belonging to a business partner that allows a user to navigate to the website sponsoring the advertisement. For example, a supplier of a home entertainment data processing system may place an advertisement at a web page provided by a movie rental business. In addition, MarCom vehicles can include advertisements placed within a business's own web site. For example, a product listing 205 provided at one web page may include a link directing a user to another web page providing further information about a product or to a web page where the user can purchase the product.

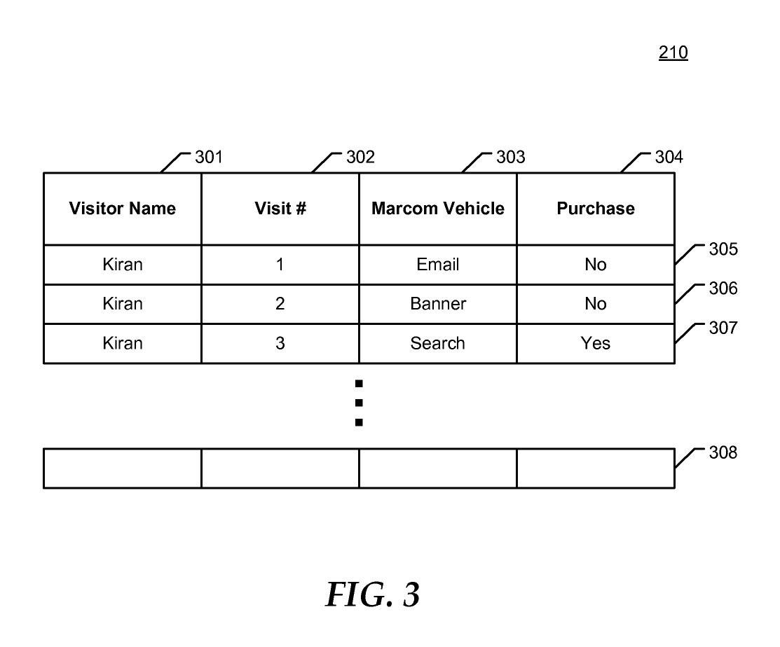

FIG. 3 shows a table of MarCom visitor records 210 in accordance with a specific embodiment of the present disclosure. The table includes a column 301 identifying the name of a visitor to a business, and a column 302 identifying a particular visit of a set of visits. The table also includes a column 303 identifying a MarCom vehicle responsible for delivering the visitor at the corresponding visit, and a column 304 identifying whether the visitor made a purchase during that particular visit. The table includes rows 305, 306, 307, and 308 wherein each row corresponds to a single visit by a single visitor. For example, the row 305 identifies a visitor named Kiran, who utilized an email MarCom vehicle to visit the business on a first occasion. Similarly, the row 306 records the fact that Kiran made a second visit to the business by clicking a banner advertisement. The row 307 is associated with a third visit by Kiran, who responded to a search engine MarCom advertisement, at which time he made a purchase. Thus, the visitor records 210 identify the various MarCom vehicles that ultimately lead Kiran to make a purchase. However, the limited number of visitor records provided at FIG. 3 is an imperfect basis on which to identify the relative importance of each MarCom vehicle in influencing Kiran to make a purchase. While the name of a visitor may be known, other information can be used to represent the identity of a visitor. For example, a visitor can be associated with an Internet Protocol (IP) address, a unique Internet browser cookie, and the like. The identity of the referring MarCom vehicle can be determined based on the particular landing page universal resource locator (URL) associated with the MarCom link, link identifier information appended to the landing page URL, and the like. For example, a link associated with a banner advertisement can be selected to navigate a visitor to a web page that is uniquely associated with the banner advertisement source location.

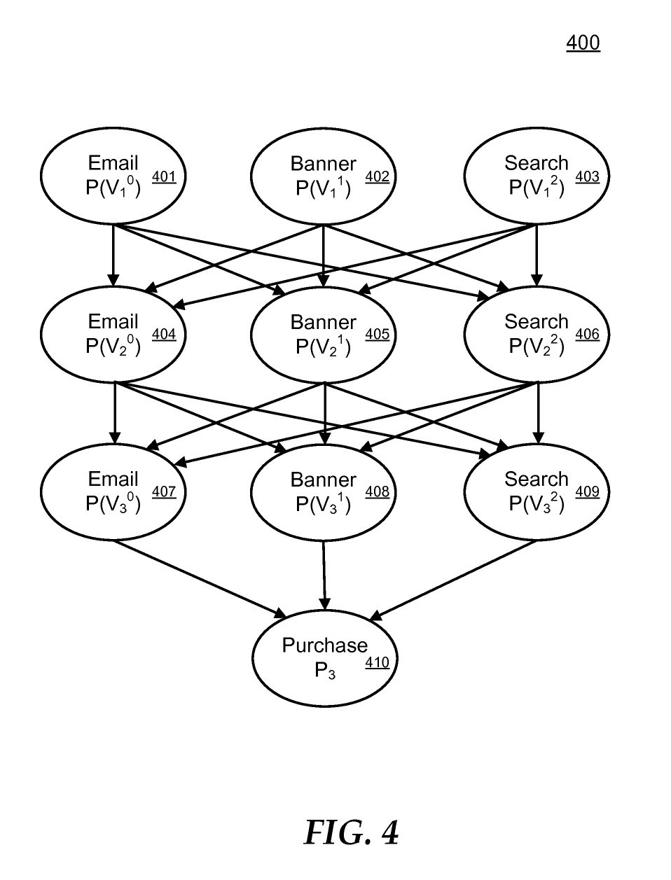

FIG. 4 shows a block diagram of a Bayesian network 400 corresponding to the visitor record information of FIG. 3 in accordance with a specific embodiment of the present disclosure. A Bayesian network, also referred to as a directed acyclic graphical model, is a probabilistic graphical model that represents a set of variables and their conditional dependencies via a directed acyclic graph. The exemplary Bayesian network 400 represents the possible sequences by which a visitor can utilize three MarCom vehicles on each of three visits, concluding the third visit with a purchase. The network 400 includes nine blocks, 401-409, and associated arrows to illustrate all of the possible ways that an individual may proceed to block 410, which corresponds to a purchase being made. Blocks 401, 402, and 403 correspond to a first visit made via a respective one of three MarCom vehicles: email; banner; and search. Blocks 404, 405, and 406 correspond to a second visit by the individual, again via any of the three vehicles. Similarly, blocks 407, 408, and 409 correspond to a third visit by the individual. Having three MarCom vehicles and three visits yields nine (3×3) possible sequences by which the individual can proceed and ultimately arrive at the purchase block 410. For example, a visitor may first click on a link provided by a search engine, corresponding to block 403, which can deliver the individual to the sponsoring business web site. At a later time, the same individual may respond to an email solicitation to visit the business web site, corresponding to block 404. Finally, the individual may notice a banner advertisement displayed at a social media web site and click on the banner, corresponding to the block 408, once again directing the individual to the business web site, at which time the individual makes a purchase.

Based on the previous example, the business can determine that the customer may have originally become acquainted with the business based on the search engine based MarCom vehicle. The business may also determine that the email advertisement was, at least partially, effective at bringing the customer to the point of completing a purchase. Similarly, the business can be aware that the visit that culminated in a purchase was in response to the banner advertisement. Conventional marketing analysis techniques may award credit for the purchase to the last MarCom vehicle, the banner advertisement, referred to as last-click attribution. Another analysis technique may award credit for the purchase to the first vehicle, the search engine, referred to as first-click attribution. Still another analysis technique may attribute credit of the sale to all three vehicles equally, known as linear attribution. The system and methods disclosed herein provide a business with a sophisticated technique to identify the merits of each MarCom vehicle based on a collection of visitor information, such as the visitor marketing information stored at the data aggregation module 101 of FIG. 1.

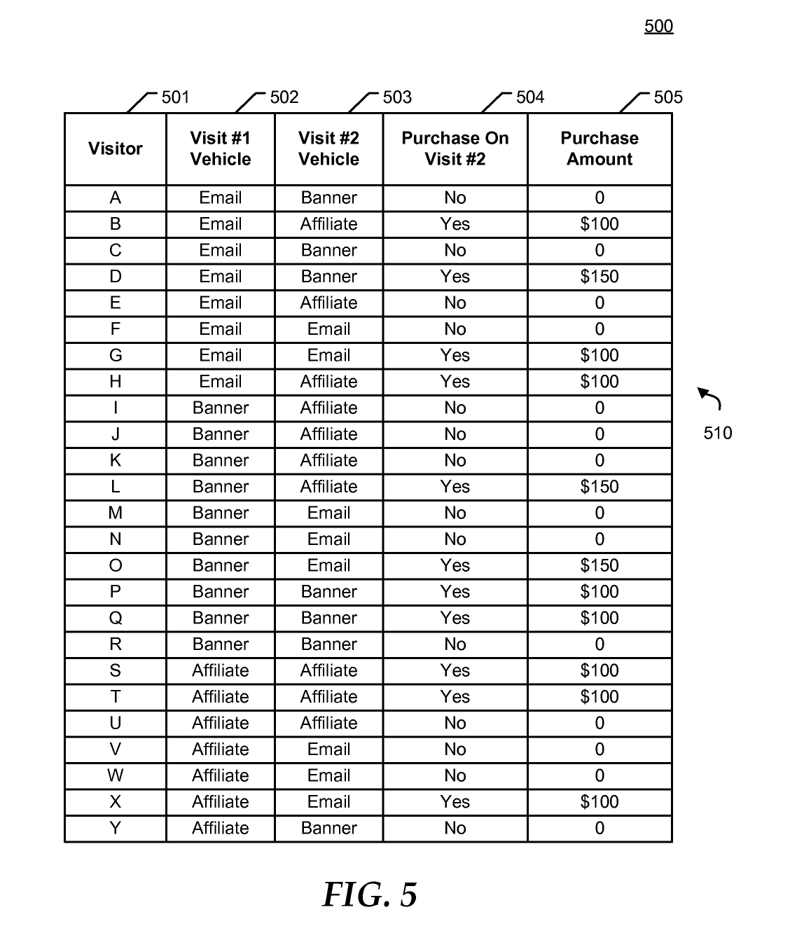

FIG. 5 shows an example of visitor marketing information 500 in accordance with a specific embodiment of the present disclosure. The visitor marking information 500 can be stored at the data aggregation module 101 of FIG. 1. The example represents twenty-five individual visitors to a business, each visitor having visited the business at least twice. A portion of those visitors made a purchase on their second visit, while some of the visitors may have made a purchase on subsequent visits or not at all. For simplicity, only purchases completed during a second visit are illustrated. In the present example, three individual MarCom vehicles are considered: email; banner; and affiliate. It will be appreciated that in a real-world scenario, the visitor marketing information can include millions of visitors, and may include a greater number of MarCom vehicles.

The visitor marketing information 500 is presented using a table having columns 501, 502, 503, 504, and 505, and twenty-five rows 510. The column 501 identifies each of the twenty-five visitors, A through Y. The column 502 identifies the MarCom vehicle associated with a corresponding visitor's first visit, and the column 503 identifies the MarCom vehicle associated with that particular visitor's second visit. The column 504 identifies whether the visitor made a purchase as a result of their second visit. The column 505 indicates a dollar amount of each purchase. For example, the first row of rows 510 identifies a visitor A, who first clicked on a link included in an email solicitation and later clicked on a banner advertisement, but did not yet make a purchase. Similarly, the second row of rows 510 identify a visitor B, who again first clicked on a link included in an email solicitation and later clicked on a link at an affiliate site, and proceeded to make a purchase based on the second visit. The amount of the purchase by visitor B is $100, as indicated at the column 505 corresponding to the visitor B.

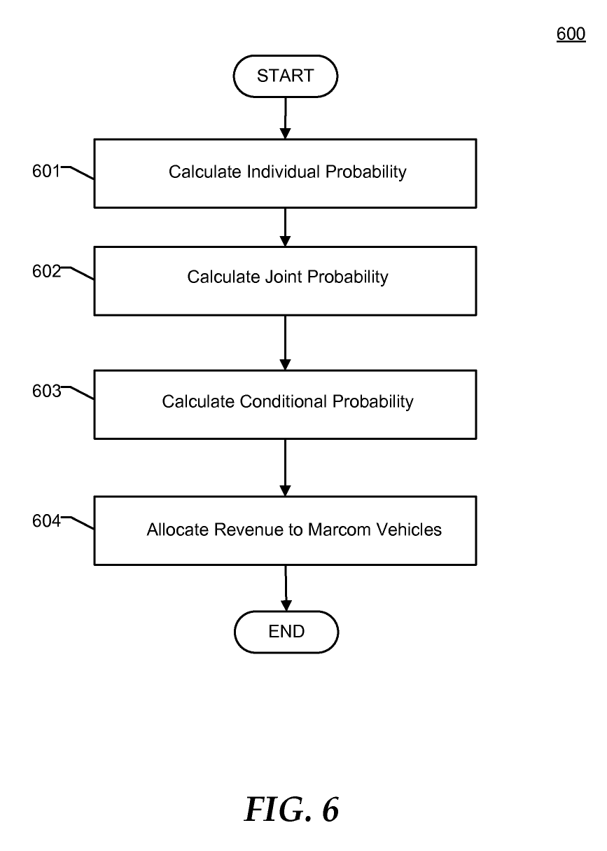

FIGS. 6-8 illustrate how the probability analysis module 102 and the sales attribution report generator 103 process the visitor marketing information 500. In particular, FIGS. 6-8 identify a method for identifying the contribution that each MarCom vehicle played in determining sales and attributing a value to each MarCom vehicle based on their respective contribution to sales.

FIG. 6 is a flow diagram showing a method 600 in accordance with a specific embodiment of the present disclosure. The method 600 can be implemented by the marketing vehicle attribution system 100 of FIG. 1. To better understand the operation of the probability analysis module 102, the methods and associated mathematical operations performed by the module are presented below. For clarity, the following notations and nomenclatures are used throughout:
The superscript (d) denotes individual MarCom vehicles. For the examples below, the variable d is associated with three MarCom vehicles as follows:
   0=Email
   1=Banner
   2=Affiliate
Individual probabilities are presented using the following notation:
Vₓ^{d} denotes a visit number (subscript x) from MarCom vehicle d
   For example,
   V₁⁰ visit that came from email on visit 1
   V₁¹ visit that came from banner on visit 1
   V₁² visit that came from affiliate on visit 1
   V₂⁰ visit that came from email on visit 2
   V₂¹ visit that came from banner on visit 2
   V₂² visit that came from affiliate on visit 2
Pₓ denotes a purchase on visit #x
   For example, P₂ denotes a purchase on a second visit
Cₓ^{d} denotes the contribution of vehicle d to purchase in visit x
   For example, for a particular sequence of vehicles, email→Banner→Purchase, denoted as V₁⁰→V₂¹→P₂,
   C₂⁰ denotes the contribution of email to purchase in visit 2 and
   C₂¹ denotes the contribution of banner to purchase in visit 2
   For this particular example,
Dₓ is the denominator of the contribution in visit x
p(Vₓ^{d}) denotes an individual probability of a visit number x being from a MarCom vehicle d
Joint probabilities are presented using the following notation:
p(Vₐ^{f} n V_{b}^{g}) denotes a joint probability that a visitor on visit a came from vehicle f and in visit b came from vehicle g, wherein
   Vₐ^{f} denotes visit number a from vehicle f, and
   V_{b}^{g} denotes visit number b from vehicle g
   (e.g. p(V₁⁰ n V₂¹) is the joint probability of a visitor coming from email on visit 1 and from banner on visit 2)
Conditional probabilities are presented using the following notation:
P(Vₐ^{f}|V_{b}^{g}) denotes the conditional probability that the visitor came from vehicle f on visit a given the infatuation that they came from vehicle g on visit b

Returning to FIG. 6, the method 600 begins at block 601 where individual probabilities are determined. For example, visitor marketing information maintained at the data aggregation module 101 includes visitor records from two or more MarCom vehicles. The probability analysis module 102 is configured to calculate an individual probability for each MarCom vehicle. Individual probability can be calculated using the following pseudo-code:

For each x (where x is the set of possible visit numbers; v=1, 2, 3,... up
to n; n being maximum visit number)
{
For each MarCom vehicle d (where d=0, ......,m; m being the maximum
number of MarCom vehicles and the vehicles being numbered in any
particular order)

{

Calculate the individual probability P(Vₓ^{d})

}
Calculate the individual probability Pₓ

}

For example, referring to FIG. 5, individual probabilities for each MarCom vehicle are:

| | | |
|---|---|---|
| email p(V₁⁰) = | 0.32 | (8/25, 8 visits came from email on visit 1) |
| banner p(V₁¹) = | 0.4 | (10/25, 10 visits came from banner on visit 1) |
| affiliate p(V1²) = | 0.28 | (7/25, 7 visits came from affiliate on visit 1) |
| email p(V₂⁰) = | 0.32 | (8/25, 8 visits came from email on visit 2) |
| banner p(V₂¹) = | 0.28 | (7/25, 7 visits came from banner on visit 2) |
| affiliate p(V₂²) = | 0.4 | (10/25, 10 visits came from affiliate on visit 2) |

The column 504 of FIG. 5 indicates that eleven visitors completed a purchase during their second visit, therefore:

p(P₂)=11/25(individual probability of purchase on visit 2)

Again referring to FIG. 6, the method 600 proceeds to block 602 where joint probabilities are determined. Joint probabilities can be calculated using the following pseudo-code:

For x=1 to n (where x is the set of possible visit numbers; v=1, 2, 3,..... up
to n; n being the maximum visit number)
{
for each d = 0 to m (where m is maximum # of MarCom vehicles)

{

for i = 1 to x−1
{

Calculate the joint probability p(Vₓ^{d} n Pₓ)

}

}

}

Continuing the previous example of FIG. 5, joint probabilities of purchase on visit 2 with a particular MarCom vehicle on visit 1 are:

| | | |
|---|---|---|
| email p(V₁⁰ n P₂) = | 0.16 | (4/25 came from email on visit 1 |
| | | and purchased in visit 2) |
| banner p(V₁¹ n P₂) = | 0.16 | (4/25 came from banner on visit 1 |
| | | and purchased in visit 2) |
| affiliate p(V₁² n P₂) = | 0.120 | (3/25 came from affiliate on visit 1 |
| | | and purchased in visit 2) |
| email p(V₂⁰ n P₂) = | 0.08 | (2/25 came from email on visit 2 |
| | | and purchased in visit 2) |
| banner p(V₂¹ n P₂) = | 0.12 | (3/25 came from banner on visit 2 |
| | | and purchased in visit 2) |
| affiliate p(V₂² n P₂) = | 0.2 | (5/25 came from affiliate on visit 2 |
| | | and purchased in visit 2) |

Once again referring to the method 600 of FIG. 6, the flow proceeds to block 603 where conditional probabilities are determined. Conditional probabilities can be calculated using the following pseudo-code:

For each x (where x is the set of possible visit numbers; v=1, 2, 3,..... up
to n; n being max visit number)
{

for i = x + 1 (i.e. for the immediately next visit)
{

for each d = 0 to m where m is max # of MarCom vehicles
{

Calculate the conditional probability p(Vₓ^{d} |Vᵢ^{d}) =
p(Vₓ^{d} n Vᵢ^{d})/p(Vᵢ^{d})

}

}

}

Output of this step is a set of probability ratios:

p(Vⱼ^{d}|Vᵢ^{d})where i,j belong to x and i<j

Continuing the previous example of FIG. 5, conditional probabilities of individual MarCom vehicle-visit number combinations with purchase on visit #2 is the ratio of the joint probabilities to the individual probability of the former. Therefore, the conditional probability of a purchase on the second visit given that the visitor came from each of the MarCom vehicles on a first visit are:

p(P₂|V₁⁰)=0.16÷0.32=0.5
conditional probability of purchase on visit 2 given that he came from email on visit 1
   Where the value 0.16 is the joint probability that the visitor came from email on visit #1 and purchased in visit #2; and the value 0.32 is the individual probability that visits came from email on visit #1.

### Similarly,

p(P₂|V₁¹)=0.16÷0.4=0.4
conditional probability of purchase on visit 2 given that he came from banner on visit 1

p(P₂|V₁²)=0.12÷0.28=0.4286
conditional probability of purchase on visit 2 given that he came from affiliate on visit 1

p(P₂|V₁⁰)=0.08÷0.32=0.25
conditional probability of purchase on visit 2 given that he came from email on visit 2

p(P₂|V₂¹)=0.12÷0.28=0.4286
conditional probability of purchase on visit 2 given that he came from banner on visit 2

p(P₂|V₂²)=0.2÷0.4=0.5
conditional probability of purchase on visit 2 given that he came from affiliate on visit 2

Once again referring to the method 600 of FIG. 6, the flow proceeds to block 604 where revenues are allocated to each MarCom vehicle. A respective portion of the total revenue associated with all MarCom vehicles is distributed to each MarCom vehicle based on the ratio of their corresponding conditional probabilities. Each visit number has a different purchase probability given that different visit number—MarCom vehicle combinations happened on prior visits. The purchase amount is divided based on the contribution of each MarCom vehicle to the purchase. Revenue allocation can be performed based on the following pseudo-code:
Calculate a total contribution denominator based on the sum of the conditional probabilities that that purchase happened on visit i given that visitor came from MarCom vehicle d on visit i−1. Note that the denominator is not a probability number, but is used for a weighting purpose.
Notation: Let W denote the set of visitors that made a purchase on a visit For each w belongs to W

{

Let k be the maximum the visit # of the visitor where a purchase
happened; the visit k is denoted as Pₖ = 1, and the MarCom vehicle
on which the visitor came be denoted as m
D_{w} = P(Vₖ^{m})
for x = 1 to x = k−1
{

/* Find the MarCom vehicle from which the visitor came on
earlier visit */
for d= 0 to m
{

if V^{d} = 1
i = d; /* Vehicle on which person came on visit x */

}
D_{w} = D_{W} + P(Vₓ^{d});

}

}
/* Calculate contribution of each vehicle */
for each w belongs to W
{

k= max visit # of visit where iP=1;
revenue = revenue on visit i;
m = value of vehicle d on which purchase was made
for x = 1 to x = k − 1
{

for d= 0 to m
{

if V^{d} = 1

i = d; /* Vehicle on which person came on visit x */

}
contribution Cₓ = P(Vₓ^{d})/D_{w};

}

}

Where D_{w} is the probability value of visit k happening from the vehicle m. D_{w} is the denominator with which the conditional probabilities are going to be divided to determine the desired attribution ratios. For example:

In the case V₁⁰→V₂¹→P₂
p(P₂|V₁⁰) is the conditional probability of purchase on visit 2 given that the visitor came from email on visit 1—say this is 0.5
p(P₂|V₂¹) is the conditional probability of purchase on visit 2 given that the visitor came from banner on visit 1—say this is 0.4
Thus, the attribution ratio, for email:banner, is 0.5:0.4, so the contribution of email is 0.5/0.9 and contribution of banner is 0.4/0.9, where the value of D_{W} is 0.9.

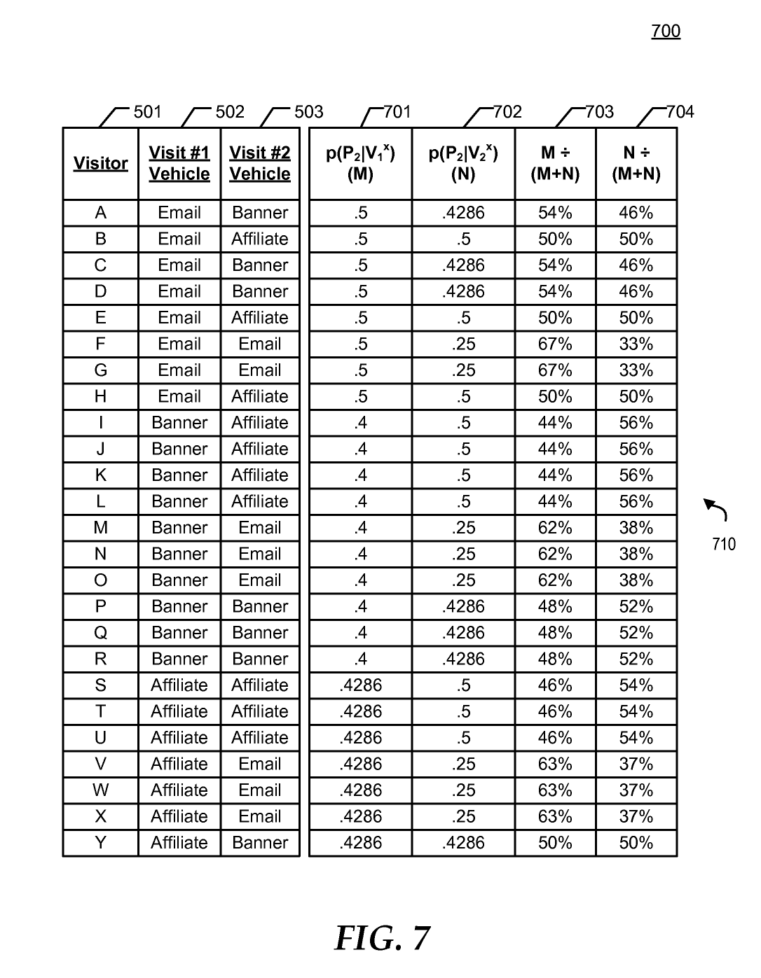

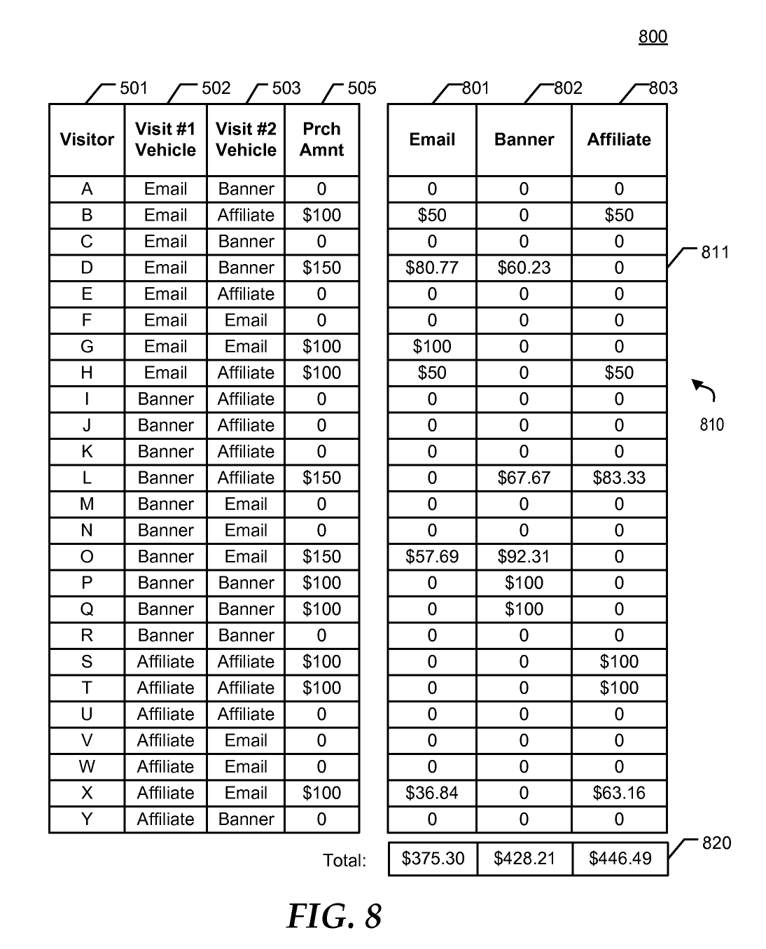

The MarCom vehicle attribution and allocation method can be better understood with reference to FIGS. 7 and 8, which illustrate the application of the techniques described above with reference to the example of FIG. 5. FIG. 7 shows a table 700 illustrating conditional probabilities and revenue allocation based on the visitor marketing information 500 of FIG. 5. The table 700 includes columns 501, 502, and 503 as shown at the table 500, and rows 710 corresponding to the rows 510 of FIG. 5. The table 700 also includes a column 701 providing the conditional probability of a visitor purchasing on a second visit based on visiting a corresponding MarCom vehicle during a first visit, a column 702 providing the conditional probability of a visitor purchasing on a second visit based on visiting a corresponding MarCom vehicle during a second visit, a column 703 providing a percentage of revenue allocated to the first MarCom vehicle, and a column 704 providing a percentage of revenue allocated to the second MarCom vehicle.

Entries at the columns 701-704 and rows 710 are based on the calculations described above. In particular, the column 701 and 702 are associated with conditional probabilities, and the columns 703 and 704 are associated with revenue allocations. For example, with reference to the first row of rows 710 associated with the visitor A, the column 701 includes the conditional probability of a purchase on visit 2 given that the visitor A came from the MarCom vehicle email on visit 1, p(P₂|V₁⁰) (hereafter referred to as M), is 0.5. Similarly, the column 702 includes the conditional probability of a purchase on visit 2 given that the visitor A came from the MarCom vehicle banner on visit 2, p(P₂|V₂¹) (hereafter referred to as N), is 0.4286.

Continuing the example with reference to the first row of rows 710 associated with the visitor A, the column 703 includes the percentage of revenue generated by the visitor A that is attributed to the first MarCom vehicle, email, and the column 704 includes the percentage of revenue generated by the visitor A that is attributed to the second MarCom vehicle, banner. For example, 54% of the revenue provided by visitor A is allocated to the MarCom vehicle email by the calculation M÷(M+N), and 46% of the revenue provided by visitor A is allocated to the MarCom vehicle banner by the calculation N÷(M+N).

FIG. 8 shows a table 800 illustrating a sales attribution report based on the visitor marketing information 500 of FIG. 5 and the allocation ratios of FIG. 7, in accordance with a specific embodiment of the present disclosure. The table 800 is an example of a MarCom revenue attribution report that can be provided by the sales attribution report generator 103 of FIG. 1. The table 800 includes columns 501, 502, 503, and 505 as shown at the table 500, and rows 810 corresponding to the rows 510 of FIG. 5. The table 700 also includes a column 801 identifying revenues allocated to the MarCom vehicle email, a column 802 identifying revenues allocated to the MarCom vehicle banner, and a column 803 identifying revenues allocated to the MarCom vehicle affiliate. Row 820 includes a summation of the amounts included at the rows of each of the columns 801-803, respectively. For example, row 811 illustrates a visitor D who first visited an exemplary business via an email MarCom, and later visits the business via a banner MarCom, at which time they make a purchase for the amount of $150.00. Based on the probability based allocation method disclosed herein, 54% of the $150.00 revenue is applied to the email MarCom vehicle (0.54×$150.00=$80.77), and 46% of the $150.00 revenue is applied to the banner MarCom vehicle (0.46×$150.00=$60.23). Because the visitor D did not utilize the affiliate MarCom vehicle, no revenue is allocated to that vehicle. If a visitor, such as the visitor A, did not make a purchase, then no revenue is attributed to any of the MarCom vehicles. Having allocated revenues associated with each visitor to the applicable MarCom vehicles, revenues attributed to each vehicle can be summed as illustrated at row 820. For example, the total revenue allocated to the email MarCom vehicle based on the 25 visitors is $375.30, the sum of all rows 810 corresponding to the row 801.

The example illustrated at FIGS. 5, 7, and 8 demonstrates a method of attributing revenue to associated MarCom vehicles based on visitors completing two visits. Similar analysis can be repeated for visitors who completed three visits, four visits, and a combination thereof. For example, revenues attributed to the email MarCom vehicle based on two visits can be combined with revenues attributed to the email MarCom vehicle based on three visits, and the like, to obtain a total value attributable to the email vehicle.

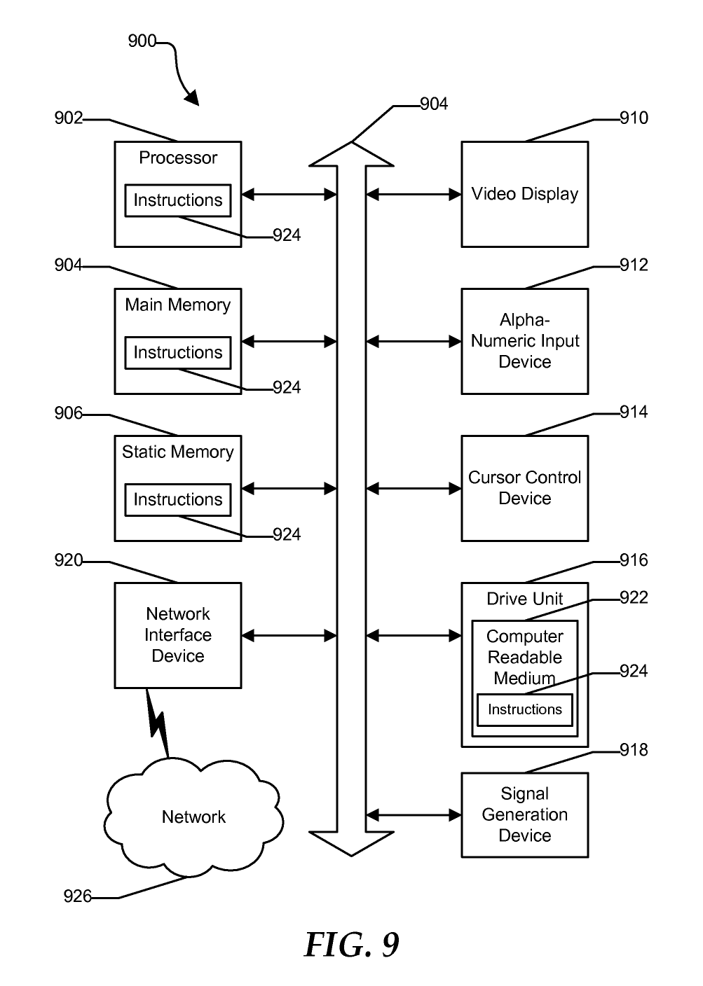

FIG. 9 shows an information handling system 900 capable of administering each of the specific embodiments of the present disclosure. The information handling system 900 can implement the MarCom vehicle attribution system 100 of FIG. 1. Alternatively, the individual data aggregation module 101, the probability analysis module 102, the sales attribution report generator 103, or other data processing systems associated with the system 100 can be implemented on one or more information handling systems. The information handling system 900 may include a processor 902 such as a central processing unit (CPU), a graphics processing unit (GPU), or both. Moreover, the information handling system 900 can include a main memory 904 and a static memory 906 that can communicate with each other via a bus 908. As shown, the information handling system 900 may further include a video display unit 910, such as a liquid crystal display (LCD), an organic light emitting diode (OLED), a flat panel display, a solid state display, or a cathode ray tube (CRT). Additionally, the information handling system 900 may include an input device 912, such as a keyboard, and a cursor control device 914, such as a mouse. The information handling system 900 can also include a disk drive unit 916, a signal generation device 918, such as a speaker or remote control, and a network interface device 920. The information handling system 900 can represent a server device whose resources can be shared by multiple client devices, or it can represent an individual client device, such as a desktop personal computer.

The information handling system 900 can include a set of instructions that can be executed to cause the computer system to perform any one or more of the methods or computer based functions disclosed herein. The computer system 900 may operate as a standalone device or may be connected such as using a network, to other computer systems or peripheral devices.

In a networked deployment, the information handling system 1000 may operate in the capacity of a server or as a client user computer in a server-client user network environment, or as a peer computer system in a peer-to-peer (or distributed) network environment. The information handling system 900 can also be implemented as or incorporated into various devices, such as a personal computer (PC), a tablet PC, a set-top box (STB), a PDA, a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 900 can be implemented using electronic devices that provide voice, video or data communication. Further, while a single information handling system 900 is illustrated, the twin “system” shall also be taken to include any collection of systems or sub-systems that individually or jointly execute a set, or multiple sets, of instructions to perform one or more computer functions.

The disk drive unit 916 may include a computer-readable medium 922 in which one or more sets of instructions 924 such as software, can be embedded. Further, the instructions 924 may embody one or more of the methods or logic as described herein. In a particular embodiment, the instructions 924 may reside completely, or at least partially, within the main memory 904, the static memory 906, and/or within the processor 902 during execution by the information handling system 900. The main memory 904 and the processor 902 also may include computer-readable media. The network interface device 920 can provide connectivity to a network 926, e.g., a wide area network (WAN), a local area network (LAN), or other network.

In an alternative embodiment, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 924 or receives and executes instructions 924 responsive to a propagated signal; so that a device connected to a network 926 can communicate voice, video or data over the network 926. Further, the instructions 924 may be transmitted or received over the network 926 via the network interface device 920.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A method implemented using a computer, the method comprising:
receiving, for each visit of a plurality of visits to a business web site, an identity of a visitor of a plurality of visitors and an identity of a corresponding marketing vehicle of a plurality of marketing vehicles; and
attributing a respective portion of sales revenue to each marketing vehicle based on:
an individual probability that a first visit by a first visitor is associated with a first marketing vehicle; and
a joint probability that a second visit by the first visitor is associated with a second marketing vehicle.

2. The method of claim 1 wherein attributing the respective portion of sales revenue is further based on a conditional probability that the first visitor made a purchase during the second visit.

3. The method of claim 1 wherein attributing the respective portion of sales revenue is further based on:
an individual probability that a first visit by a second visitor is associated with the first marketing vehicle;
a joint probability that a second visit by the second visitor is associated with the second marketing vehicle; and
a conditional probability that the second visitor made a purchase during the second visit.

4. The method of claim 1 further comprising determining, for each visit to the business web site, whether a purchase was made.

5. The method of claim 1 wherein attributing the respective portion of sales revenue is further based on:
an individual probability that a first visit by a second visitor is associated with a third marketing vehicle;
a joint probability that a second visit by the second visitor is associated with the fourth marketing vehicle; and
a conditional probability that the second visitor made a purchase during the second visit.

6. The method of claim 1 wherein the plurality of marketing vehicles includes at least two vehicles selected from a group consisting of a web page banner advertisement, a search engine search result advertisement, and an email solicitation.

7. The method of claim 1 wherein the first marketing vehicle represents a collection of two or more individual advertising vehicles.

8. The method of claim 1 further comprising updating an emphasis of a marketing campaign based on the attributing.

9. The method of claim 1 wherein the visitor identity is determined based on a browser cookie.

10. The method of claim 1 wherein the marketing vehicle identity is determined based on a universal resource locator associated with a marketing vehicle link.

11. A tangible computer readable medium storing a set of instructions to manipulate a processing system to:
receive, for each visit of a plurality of visits to a business web site, an identity of a visitor of a plurality of visitors and an identity of a corresponding marketing vehicle of a plurality of marketing vehicles; and
attribute a respective portion of sales revenue to each marketing vehicle based on:
an individual probability that a first marketing vehicle is associated with a first visit by a first visitor at a first time;
an individual probability that a second marketing vehicle is associated with a second visit by the first visitor at a second time, the second time after the first time;
an individual probability that a third marketing vehicle is associated with a first visit by a second visitor at a third time; and
an individual probability that a fourth marketing vehicle is associated with a second visit by the second visitor at a fourth time, the fourth time after the third time,
wherein the first, second, third, and fourth marketing vehicle include at least two different marketing vehicles.

12. The computer readable medium of claim 11 wherein attributing the respective portion of the sales revenue is further based on a joint probability that the first marketing vehicle is associated with the first visit and that the second marketing vehicle is associated with the second visit.

13. The computer readable medium of claim 11 wherein attributing the respective portion of the sales revenue is further based on a conditional probability that the first visitor made a purchase during the second visit given that the first marketing vehicle enabled the first visit by the first visitor.

14. The computer readable medium of claim 11 wherein attributing the respective portion of the sales revenue is further based on an individual probability that the third marketing vehicle is associated with a third visit by the first visitor at a fifth time, the fifth time after the second time.

15. The computer readable medium of claim 14 wherein attributing the respective portion of sales revenue is further based on a conditional probability that the first visitor made a purchase during the third visit given that the second marketing vehicle enabled the second visit by the first visitor.

16. The computer readable medium of claim 11 further comprising updating an emphasis of a marketing campaign based on the attributing.

17. The computer readable medium of claim 11 wherein the first marketing vehicle represents a collection of two or more individual advertising vehicles.

18. An information handling system comprising:
a memory;
a microprocessor operatively connected to the memory; and
computer-readable program code stored in the memory and executable by the microprocessor to:
receive, for each visit of a plurality of visits to a business web site, an identity of a visitor of a plurality of visitors and an identity of a corresponding marketing vehicle of a plurality of marketing vehicles; and
attribute a respective portion of sales revenue to each marketing vehicle based on:
individual probabilities that a particular marketing vehicle is associated with a respective visit of the plurality of visits; and
joint probabilities that a particular marketing vehicle is associated with a respective visit of the plurality of visits.

19. The information handling system of claim 18 wherein attributing a respective portion of sales revenue is further based on conditional probabilities that a purchase occurs on a subsequent visit given that a particular marketing vehicle is associated with a respective prior visit.

20. The information handling system of claim 18 further comprising updating an emphasis of a marketing campaign based on the attributing.
